(19) United States
(12) Patent Application Publication
(10) Pub. No.: US 2025/0371599 A1
(43) Pub. Date: Dec. 4, 2025

(54) MACHINE LEARNED MODEL FOR ITEM RECOMMENDATIONS FOLLOWING FAILED ATTEMPTS

(71) Applicant: Maplebear Inc., San Francisco, CA (US)

(72) Inventor: Naval Shah, Toronto (CA)

(21) Appl. No.: 18/678,484

(22) Filed: May 30, 2024

(51) Int. Cl. G06Q 30/0601; G06Q 10/0875

(52) U.S. Cl. CPC G06Q 30/0631; G06Q 30/0635; G06Q 30/0641; G06Q 10/0875

(57) ABSTRACT

A machine learned model for item recommendations following failed attempts to purchase those items. During a session, an online system receives a request to fulfill an order from a user device. The system receives a message indicating that an item from the order was not fulfilled. The system logs the item in connection with a profile of the user stored in a database of the online system. During a subsequent session with the user device, the system determines that the logged item is available for fulfillment. The system applies the model to output an intent score indicative of an intent of a user of the user device to acquire the logged item. The logged item is ranked based on the intent score, and a user interface is generated that includes a recommendation to acquire the logged item. The system causes the user device to display the generated user interface.

### BACKGROUND

Out of stock items can be detrimental to customer satisfaction of online orders. Particularly in cases where an order has already been placed, and it is discovered later that an item in the order is not available (e.g., out of stock, not available at their location, not able to be found). Conventionally, if an item is not available, options generally include substituting the item with something else, or to refund the item and not receive it. However, in subsequent orders the customer may still be interested in those earlier unavailable items, but may not remember to add them to the order (or even look for them again). This is especially true if those items are not usual staples for the customer or if the customer had never purchased the item (e.g., it would not be part of the purchase history used for recommendations for items that were previously purchased). As such, there may be a high chance that the customer is still interested in purchasing the item, but conventional systems often do not include a mechanism to remind the customer about the item.

### SUMMARY

In accordance with one or more aspects of the disclosure, a machine learned model for item recommendations following failed attempts to purchase those items is described. An online system may track items that were part of shopping lists of a user (e.g., customer), but were later found to be unavailable and were not fulfilled as part of orders corresponding the shopping lists. The online system may track these items using a database. The online system may determine that the customer is generating a shopping list for an order from a retailer location. The online system may identify one or more tracked item(s) that are currently in stock at the retailer location and that are not part of the shopping list. The online system may retrieve model inputs including the identified one or more tracked item(s). The online system may determine one or more of the tracked items and their associated scores by applying the model inputs including the identified one or more tracked items to an intent prediction model. The online system may select one or more of the tracked items based in part on the associated scores. The online system generates, based on the ranking, a user interface including one or more recommendations to acquire the selected one or more tracked items. The online system may cause the user device to display the generated user interface.

In some aspects, the techniques described herein relate to a method, performed at an online system including a processor and a non-transitory computer readable medium, including: during a first session between the online system and a user device, receiving, from the user device, a request to fulfill an order; receiving, at the online system, a message indicating that an item from the order was not fulfilled; logging the item in connection with a profile of the user stored in a database maintained by the online system; during a second session between the online system and the user device, the second session subsequent to the first session, determining that the logged item is available for fulfillment; applying an intent prediction model to output an intent score indicative of an intent of a user of the user device to acquire the logged item, wherein the intent prediction model was trained by: accessing a set of training examples including shopping intent training data, user training data, item training data, and order training data, applying the intent prediction model to the set of training examples to generate a training output corresponding to a predicted training set of recommended items and associated training intent scores, back-propagating one or more error terms obtained from one or more loss functions to update a set of parameters of the intent prediction model, and one or more of the error terms are based on a difference between a label applied to a test interaction of the set of training examples and the predicted training set of recommended items and associated training intent scores, and stopping the back-propagation after the one or more loss functions satisfy one or more criteria; ranking the logged item for the user based on the intent score; generating, based on the ranking, a user interface including a recommendation to acquire the logged item; and causing the user device to display the generated user interface.

In some aspects, the techniques described herein relate to a non-transitory computer-readable storage medium including stored instructions, the instructions when executed by a processor of an online system, cause the online system to: during a first session between the online system and a user device, receive, from the user device, a request to fulfill an order; receive, at the online system, a message indicating that an item from the order was not fulfilled; log the item in connection with a profile of the user stored in a database maintained by the online system; during a second session between the online system and the user device, the second session subsequent to the first session, determine that the logged item is available for fulfillment; apply an intent prediction model to output an intent score indicative of an intent of a user of the user device to acquire the logged item, wherein the intent prediction model was trained by: accessing a set of training examples including shopping intent training data, user training data, item training data, and order training data, applying the intent prediction model to the set of training examples to generate a training output corresponding to a predicted training set of logged items and associated training intent scores, back-propagating one or more error terms obtained from one or more loss functions to update a set of parameters of the intent prediction model, and one or more of the error terms are based on a difference between a label applied to a test interaction of the set of training examples and the predicted training set of logged items and associated training intent scores, and stopping the back-propagation after the one or more loss functions satisfy one or more criteria; rank the logged item for the user based on the intent score; generate, based on the ranking, a user interface including a recommendation to acquire the logged item; and cause the user device to display the generated user interface.

In some aspects, the techniques described herein relate to an online system including: a processor; and a non-transitory computer readable storage medium having instructions encoded thereon that, when executed by the processor, cause the online system to: during a first session between the online system and a user device, receive, from the user device, a request to fulfill an order, receive, at the online system, a message indicating that an item from the order was not fulfilled, log the item in connection with a profile of the user stored in a database maintained by the online system, during a second session between the online system and the user device, the second session subsequent to the first session, determine that the logged item is available for fulfillment, apply an intent prediction model to output an intent score indicative of an intent of a user of the user device to acquire the logged item, wherein the intent prediction model was trained by: accessing a set of training examples including shopping intent training data, user training data, item training data, and order training data, applying the intent prediction model to the set of training examples to generate a training output corresponding to a predicted training set of recommended items and associated training intent scores, back-propagating one or more error terms obtained from one or more loss functions to update a set of parameters of the intent prediction model, and one or more of the error terms are based on a difference between a label applied to a test interaction of the set of training examples and the predicted training set of recommended items and associated training intent scores, and stopping the back-propagation after the one or more loss functions satisfy one or more criteria, rank the logged item for the user based on the intent score, generate, based on the ranking, a user interface including a recommendation to acquire the logged item, and cause the user device to display the generated user interface.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3A is an example sequence diagram describing generation of a list of tracked items, in accordance with some embodiments.

FIG. 3B is an example sequence diagram describing determination of items using an intent prediction model and the list of tracked items of FIG. 3A

FIG. 4 illustrates an example ordering interface associated with a storefront that includes a carousel, in accordance with some embodiments.

FIG. 5 is a flowchart for a method of determining item recommendations following failed attempts, in accordance with some embodiments, in accordance with some embodiments.

### DETAILED DESCRIPTION

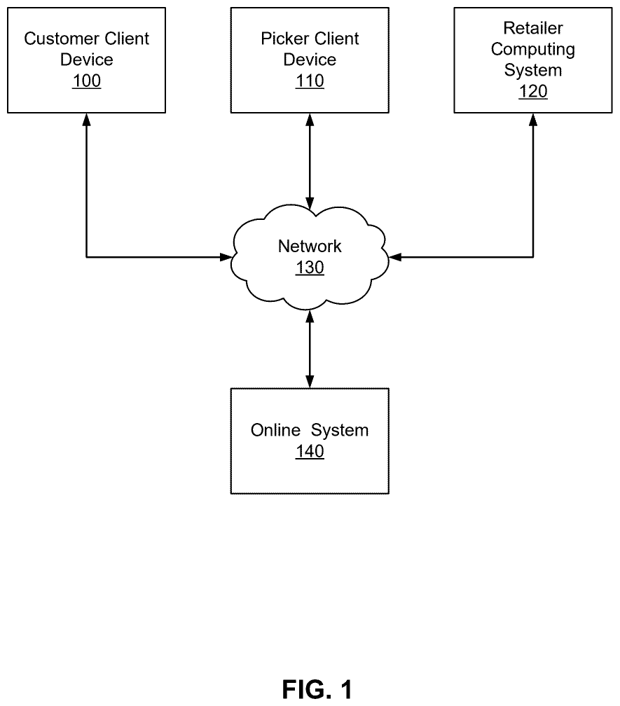

FIG. 1 illustrates an example system environment for an online system 140, in accordance with one or more embodiments. In some embodiments, the online system 140 may be an online concierge system. The system environment illustrated in FIG. 1 includes a customer client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 may be a smart cart. A smart cart is a physical cart that includes sensors (e.g., camera, scanner, scale, etc.) to detect items placed in the smart cart, a display, and a controller. For example, the controller may use data from the sensors to identify items placed in the cart, and present which items are in the smart cart (and, e.g., a current total price of the items) using the display. The controller also may add and/or remove items to a shopping cart (online) of the online system 140 to ensure that the content of the shopping cart is the same as the content of the smart cart. As items are added to the shopping cart, a shopping list for the order may be updated accordingly. The controller may also use the display to present recommendations for items in accordance with instructions from the online system 140. In some embodiments, once a customer is done shopping, the customer may pay via the smart cart without having to go through the conventional check-out line. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item,” as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that make up the items on an online shopping cart. The items in the online shopping cart are those the user has selected for an order but that have not yet been finalized for an order. The ordering interface allows a customer to update the shopping list, e.g., by changing the quantity of items, adding or removing items, or adding instructions for items that specify how the item should be collected. Note in some embodiments a customer may generate a shopping list for an in-person order. An in-person order is an order where items on the shopping list are collected and purchased by the customer via, e.g., the ordering interface.

Note in some instances a customer may order an item that ends up being unavailable. For example, the customer may have ordered an item, and the picker fulfilling the order (or the customer using a smart cart) discovered that the item was out-of-stock or was unable to find the item, and the order for the item was not able to be fulfilled. In other examples, the customer may have tried to order the item, but it ended up not being available within the geographical area (e.g., a threshold distance from a delivery location of the customer) of the customer.

The ordering interface may present information describing one or more items the customer has previously unsuccessfully attempted to purchase. For example, an item that a customer had previously ordered or attempted to order but ended up being unavailable. The customer client device 100 receives the information describing these items from the online system 140. The ordering interface may present, e.g., item recommendation(s) for these item(s) using a carousel. In some embodiments, the ordering interface may present, in accordance with instructions from the online system 140, item recommendation(s) for these items in a separate section than item recommendations for items the customer had previously purchased. In some embodiments, the ordering interface may present item recommendations for these items during the checkout process for an order. In some embodiments, responsive to receiving instructions from the online system 140 that an item is now available for purchase, the ordering interface provides a notification to the customer.

The customer client device 100 may receive additional content from the online system 140 to present to a customer. For example, the customer client device 100 may receive appeasements (e.g., refund, coupon, etc.) for an unavailable item, coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

In some embodiments, an order may be for items from a retailer location, and the picker may discover that an item that is part of the order is not available at the retailer location (e.g., the item is out-of-stock, the picker is not able to find the item, etc.). The picker may communicate the lack of availability of the item to the online system 140, and receive instructions how to proceed (e.g., via the collection interface) regarding the item from the online system. For example, in some embodiments, the collection interface may instruct the picker to proceed with fulfilling the order without the unavailable item. And for this order, the online system 140 may provide an appeasement (e.g., refund of money for the item, incentive, etc.) for the item that was unavailable.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer and/or an in-person order (e.g., customer collects the items from the retailer location). The online system 140 receives orders from a customer client device 100 through the network 130. In some embodiments, the online system 140 selects a picker to service the customer's order and transmits the order to a picker client device 110 associated with the picker. The picker collects the ordered items from a retailer location and delivers the ordered items to the customer. For in-person orders, the customer collects the items from the retailer location, and communicates which items have been collected and ultimately paid for using the customer client device 100. The online system 140 may charge a customer for the order and provide a portion of the payment to the retailer, and in some embodiments also provide a portion of the payment to the picker.

For example, the online system 140 may allow a customer to order groceries from a grocery store retailer. The customer's order may specify which groceries they want delivered from the grocery store and the quantities of each of the groceries. The customer client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140.

In some embodiments, the online system 140 may receive an indication (e.g., from the picker client device 110, the retailer computing system 120, or the customer client device 100) that a requested item (e.g., saffron) from an order to be fulfilled at a retailer location is unavailable at the retail location. The online system 140 may log the requested item in a database in connection with a profile of the customer. For example, the online system may update a list of tracked items in the database with the unavailable item (e.g., add saffron to the list). The tracked items are items that the user has tried to order in the past, but were later found to be unavailable and were not fulfilled as part of the order. In contrast, a purchase history describes items that were successfully fulfilled in previous orders by the customer. The online system 140 may update the list of tracked items for a variety of reasons different from those above. For example, the online system 140 may remove an item from the list of tracked items once an order for the item is successfully fulfilled, the item has been on the list of tracked items for more than a threshold period of time, etc.

The online system 140 may determine that the customer is generating a shopping list during a subsequent session between the online system 140 and the customer client device 100. The online system 140 may identify, from the list of tracked items, one or more items that are currently in stock and available to purchase and are not part of the shopping list. The online system 140 may retrieve one or more model inputs associated with the identified one or more items (e.g., how long an item has been on the list of tracked items, search history of the customer, etc.). The online system 140 may determine one or more items, of the identified one or more items, and associated intent scores by applying the retrieved model inputs to an intent prediction model.

The intent prediction model estimates a likelihood that the customer is still interested in purchasing items from the list of tracked items that are now available. The items output from the intent prediction model are items that the intent prediction model predicts that the customer is likely still interested in purchasing, but was unsuccessful in purchasing in the past (e.g., item was out of stock). Each of the items have an associated score (e.g., intent score) that it is associated with a probability the customer would still be interested in purchasing that item. The online system 140 selects one or more items from the items output from the model based in part on the associated intent scores. The online system 140 provides information describing the selected one or more items to the customer client device 100 associated with the customer, and instructions to present the selected one or more items (e.g., as recommendations on a carousel, during the checkout process, etc.).

As an example, a customer may have tried to order saffron for the first time from a retailer, but it was unavailable, and the online system 140 added saffron to the list of tracked items for the customer. Note that as the customer had not previously ordered saffron using the online system 140, it is likely the customer would forget to purchase it in a subsequent shopping trip. In contrast, a staple that is regularly purchased (e.g., eggs, milk, etc., that the customer buys frequently) is likely to be remembered by the customer, and in cases where it is not, such items are captured in item recommendations for previously purchased items.

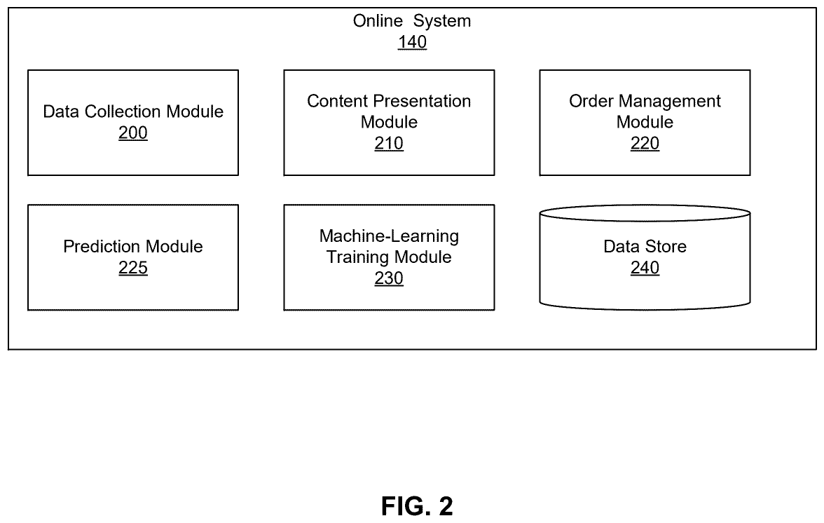

The customer may commence a new order at a later time. In some embodiments, the next order the customer starts for a retailer location. The online system 140 may identify that saffron and potentially other items on the list of tracked items are now available at the retailer location, and retrieve model inputs associated with the identified item(s). The online system 140 may apply the retrieved model inputs associated with the identified items to the intent prediction model. The intent prediction model outputs one or more items and their associated intent scores. In this example, an intent score associated with saffron is likely relatively high as it has not been purchased before by the customer and has been on the list of tracked items for a short period of time. Accordingly, the online system 140 may select saffron from the one or more items output from the intent prediction model. The online system 140 may then provide an item recommendation for the saffron to the customer client device 100 with instructions to present the item recommendation on the ordering interface (e.g., as part of a carousel). The customer may complete the order. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a prediction module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, customer location during the order (e.g., for an in-person order), a timeframe within which the customer wants the order delivered, or some combination thereof. Order data may further include information describing how the order was serviced, such as which picker serviced the order, when the order was delivered, or a rating that the customer gave the delivery of the order.

Additionally, the data collection module 200 collects shopping intent data, which is information or data that describes customer buying intent for items. Shopping intent data may include, e.g., shopping cart histories, order histories corresponding to the shopping cart histories, how items were added to the shopping cart of the customer, regular purchases data, search histories of the customer, list of tracked items, times items have been on the list of tracked items, items in which appeasements were paid (e.g., refund provided for item that was unavailable), other information relevant to determining customer buying intent for items, or some combination thereof.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents an online catalog of all items that are available to the customer, which the customer can browse to select items to order. The content presentation module 210 also may identify items that the customer is most likely to order and present those items to the customer. For example, the content presentation module 210 may score items and rank the items based on their intent scores. The content presentation module 210 displays the items with intent scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

In some embodiments, the order management module 220 tracks a location of the customer within a retailer location. For example, the customer may be performing in-person order at the retailer location. The order management module 220 uses sensor data from the customer client device 100 or from sensors in the retailer location to determine the location of the customer in the retailer location. The order management module 220 may transmit to the customer client device 100 instructions to display a map of the retailer location indicating where in the retailer location the customer is located. Additionally, the order management module 220 may instruct the customer client device 100 to display the locations of items for the customer to collect, and may further display navigation instructions for how the customer can travel from their current location to the location of a next item to collect for an order.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

In some embodiments, the prediction module 225 determines a mismatch between items on a shopping list and the items actually fulfilled in the corresponding order. For example, a customer conducting an in-person order (e.g., via smart cart) may have had saffron on their shopping list, but was unable to find it in the retailer location and/or it may have been unavailable at the retailer location. As such, while the shopping list included saffron, no saffron was purchased when the order was finalized, thereby resulting in a mismatch between items on the shopping list and the items actually fulfilled as part of the order. In another example, the prediction module 225 may receive, after the customer has already placed an order for items on a shopping list for a retailer location, an indication that a requested item from the order is unavailable at the retailer location. For example, the picker may discover that the requested item is unavailable at the requested source location (e.g., retailer location ran out of stock of the item after the order had been finalized), and use the picker client device 110 to provide the indication to the online system 140. The prediction module 225 may use the indication to determine the mismatch between the items on the shopping list and items fulfilled in the order.

The prediction module 225 tracks items that were part of shopping lists of the customer, but were later found to be unavailable and were not fulfilled as part of orders corresponding to the shopping lists. For example, responsive to determining a mismatch between items on a shopping list of an order and the items fulfilled for the order, the prediction module 225 may identify one or more items of the shopping list that were not fulfilled in the order. The prediction module 225may determine whether the one or more items are part of a list of tracked items, and if not part of the list of tracked items, add them to the list of tracked items. The tracked items are items that the user has tried to order in the past, but were later found to be unavailable and were not fulfilled as part of the order.

The prediction module 225 may update the list of tracked items. As noted above, the prediction module 225 may update the list of tracked items with items, of the one or more items, that are not already part of the list of tracked items. In some embodiments, the prediction module 225 may remove an item from the list of tracked items once an order for the item is successfully fulfilled. For example, a subsequent order of the customer may include an item from the list of tracked items for that customer. Once the order is successfully fulfilled for the item, the prediction module 225 may remove the item from the list of tracked items. In some embodiments, the prediction module 225 may remove an item from the list of tracked items after the item has been on the list of tracked items for more than a threshold period of time. The threshold period of time can be set to be relatively short (e.g., a week or less). This can help ensure that the item is still of interest to the customer, as the customer would have been less likely to find and purchase the item outside of the online system 140.

Responsive to generation of a shopping list associated with a retailer location, the prediction module 225 may identify, from the list of tracked items, one or more items that are currently in stock at the retailer location and are not part of the shopping list. In some embodiments, the prediction module 225 may identify which of the tracked items are from the retailer associated with the shopping list. The prediction module 225 may coordinate with the data collection module 200 to determine which of the identified tracked items are in stock at the retailer and are not already part of the shopping list. In some embodiments, the prediction module 225 may determine availability of items on the list of tracked items using, e.g., an availability model. The availability model is described in detail in U.S. application Ser. No. 17/570,038, filed on Jan. 6, 2022, which is hereby incorporated by reference in its entirety.

The prediction module 225 retrieves model inputs, including the available tracked item(s), for use with the intent prediction
model to determine one or more items that may be relevant to the customer. The model inputs may include, e.g., shopping intent data associated with the customer (e.g., shopping cart histories, order histories corresponding to the shopping cart histories, how items were added to the shopping cart of the customer, regular purchases data associated with the customer, search histories of the customer, list of tracked items, times items have been on the list of tracked items, items for which appeasements were paid, other information relevant to determining customer buying intent for items,), item data (e.g., availability information of items on the list of tracked items at one or more retailers), customer data, order data (e.g., location of customer in retailer during an order), some other information relevant to determining whether a customer still intends to purchase an item, or some combination thereof.

The intent prediction model is a machine learned model that uses the model inputs to determine one or more items from available tracked items and their associated intent scores. The prediction module 225 may determine the one or more items and their associated intent scores by applying the model inputs to the intent prediction model. Each item of the one or more items includes an associated intent score. In some embodiments, the associated intent score is a confidence score that the customer intends to purchase the item associated with the intent score.

The intent prediction model is trained to predict which previously unavailable items the customer still intends to purchase (e.g., as part of their next order) and outputs these items with associated intent scores. The model inputs are data used by the intent prediction model to facilitate the predictions. For example, the intent prediction model may determine one or more items using some or all of the list of tracked items that are currently in stock at the retailer location. In other embodiments, the intent prediction model may use the shopping lists of the customer and their corresponding orders to identify one or more items that are likely to be of interest to the customer (e.g., to add to their shopping list in their next order).

In generating the intent scores for the one or more items the intent prediction model uses one or more of the model inputs. In some embodiments, for in-person orders, the intent prediction model may generate the intent scores based in part on locations of the customer in the retailer and availability information of the previously unavailable item. For example, if the previously unavailable item were actually in stock at a first location within the retailer location, but the customer never went to the first location it is likely the customer could not find the item and would still be interested in purchasing the item. Likewise, if the customer actually went to the first location it may be that the customer simply decided not to purchase the item. For example, the intent prediction model may use item data to determine whether an item of the tracked items was out of stock at a retailer location at a time range associated with a shopping list that included the item. And the order data may describe location information of the customer within the retailer location during the time range. The intent prediction model may use the item information and the order information to determine the one or more items and their associated intent scores.

The intent prediction model may generate the intent scores of one or more of the items based in part on associated regular purchases data associated with the customer. For example, if the customer purchases an item every week or two, it may be a staple item for the customer and it probably is not something the customer will need to be reminded of or not something the customer has forgotten. The intent prediction model may analyze timing of purchases for the previously unavailable items to determine that the item should be categorized under regular purchases data.

The intent prediction model may generate the intent scores for items based in part on how the items were added to shopping lists. For example, in a previous order that had a shopping list where an item was marked “likely out of stock” and the customer still requested it, it is a strong signal that the customer likely still intends to purchase the item. Accordingly, the intent prediction model may increase the intent score for the item.

The intent prediction model may generate the intent scores for items based in part on the search history of the customer. For example, if the customer searches for an item that is not available in their location (e.g., because the product has not yet reached that market or because it is not stocked at the retailer location), that may be a signal that the customer would intend to purchase the item. The intent prediction model may adjust the intent score of the item accordingly.

The prediction module 225 may select one or more items from the items output from the intent prediction model based on their associated intent scores. In some embodiments, the prediction module 225 may rank the one or more items by their associated intent scores. The prediction module 225 may select any of the ranked one or more items that have intent scores above a threshold intent score (e.g., threshold confidence score). The threshold intent score may be set relatively high (e.g., >90%) to facilitate a high probability of the customer purchasing the selected item(s).

The prediction module 225 may provide item recommendations for the selected one or more items to the customer client device 100 associated with the customer. In some embodiments, the prediction module 225 may also instruct the customer client device to present the item recommendation(s) in a particular way (e.g., as part of a carousel, in a separate section than item recommendations for previously purchased items, during a checkout process, etc.).

The machine learning training module 230 trains machine learning models (e.g., the intent prediction model) used by the online system 140. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include shopping intent training data, customer training data, order training data, picker training data, or item training data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

For example, in some embodiments, the machine learning training module 230 may train the intent prediction model by accessing a set of training examples including shopping intent training data, user training data, item training data, and order training data. The machine learning training module 230 may apply the intent prediction model to the set of training examples to generate a training output corresponding to a predicted training set of logged items (items on a list of tracked items) and associated training scores (e.g., intent scores). The machine learning training module 230 may back-propagate one or more error terms obtained from one or more loss functions to update a set of parameters of the intent prediction model, and one or more of the error terms are based on a difference between a label applied to a test interaction of the set of training examples and the predicted training set of logged items and associated training intent scores. The machine learning training module 230 may stop the back-propagation after the one or more loss functions satisfy one or more criteria.

In some embodiments, the machine learning training module 230 may also update the intent prediction model using information gathered during use. For example, the machine learning training module 230 may collect shopping intent data, customer data, order data, picker data, and item data for customers, and use as corresponding shopping intent training data, customer training data, order training data, picker training data, and item training data to retrain the intent prediction model.

The data store 240 stores data used by the online system 140. For example, the data store 240 stores customer data, item data, order data, shopping intent data, and picker data for use by the online system 140. The data store 240 also stores trained machine learning models (e.g., the intent prediction model) trained by the machine learning training module 230. For example, the data store 240 may store the set of parameters for a trained machine learning model on one or more non-transitory, computer-readable media. The data store 240 uses computer-readable media to store data, and may use databases to organize the stored data.

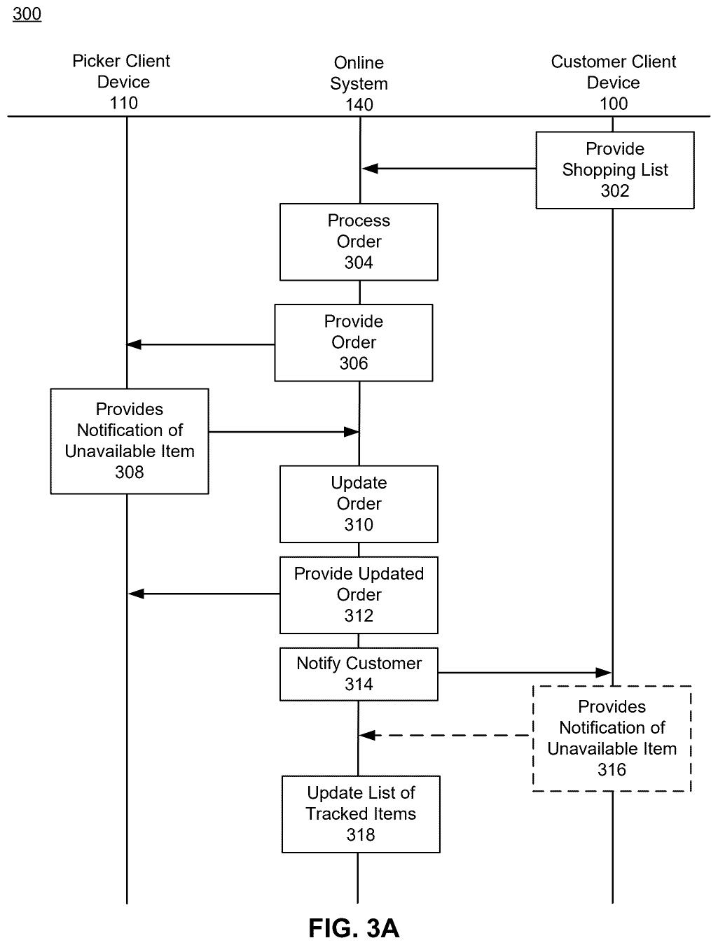

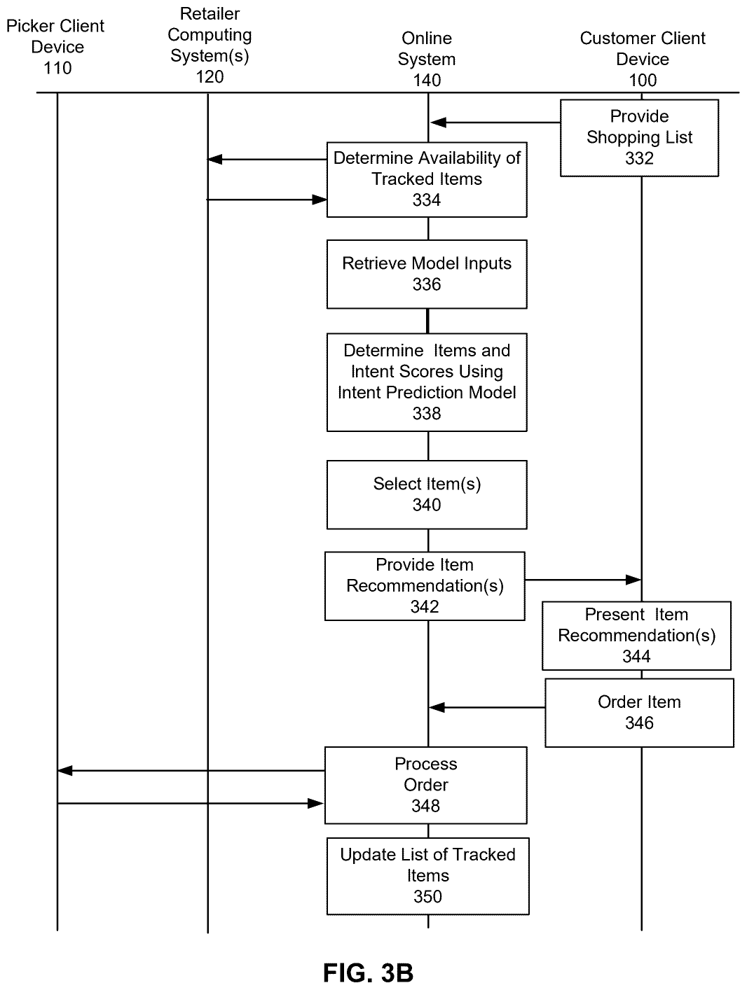

FIG. 3A is an example sequence diagram 300 describing generation of a list of tracked items, in accordance with some embodiments. Alternative embodiments may include more, fewer, or different interactions from those illustrated in FIG. 3A, and the steps may be performed in a different order from that illustrated in FIG. 3A.

A customer associated with the customer client device 100 generates a shopping list that is provided 302 to the online system 140. The shopping list includes items to be purchased from a retailer location as part of an order.

The online system 140 processes 304 the order, by identifying a picker associated with the picker client device 110 to shop for the order at the requested retailer location. The online system 140 may, e.g., identify the picker from a pool of pickers based on their locations relative to the requested source location, available cargo capacities of their vehicles, picker efficiency scores, size and number of requested items, etc. The online system 140 assigns the picker to handle the order. The online system 140 provides 306 the assignment of the order to a picker client device 110 associated with the picker.

The picker shops for items on the shopping list of the order at the requested retailer location. The picker gathers the one or more items of the order from the requested retailer location. In the illustrated embodiment, the picker is either unable to find one or more of the items at the retailer location and/or the one or more items are out of stock at the retailer location. The picker updates the order to note that the requested one or more items is unavailable, and the picker client device 110 notifies 308 the online system 140 that the requested one or more items are unavailable.

Responsive to receiving the notification, the online system 140 may update 310 the order to account for the one or more items that were unavailable (also referred to as unavailable items). For example, the online system 140 may provide appeasements (e.g., a refund) for some or all of the one or more unavailable items, and update the order so that it no longer includes the one or more unavailable items. The online system 140 provides 312 the updated order to the picker client device 110, and the picker fulfills the updated order. The online system 140 may also provide 314 a notification to the customer client device 100 of the one or more unavailable items, the updated order, and appeasement(s).

Note in some embodiments, the order is an in-person order that is to be fulfilled by the customer. For example, the customer may generate a shopping list for an in-person order. In these embodiments, the customer shops for items on the shopping list of the order at the retailer location. In the illustrated embodiment, there may be one or more items where the customer is either unable to find one or more of the items at the retailer location and/or the one or more items are out of stock at the retailer location. The customer client device 100 may provide 316 a listing of the one or more items that were unavailable (also referred to as unavailable items) to the online system 140.

The online system 140 may update 318 a list of tracked items with the one or more unavailable items. The list of tracked items is specific to the customer, and each item on the list is associated with a time when it was added to the list. In some embodiments, where an unavailable item is already on the list of tracked items, the online system 140 may update the time of the item to the most recent order for that item where it was unfulfilled.

FIG. 3B is an example sequence diagram 330 describing determination of items using an intent prediction model and the list of tracked items of FIG. 3A. Alternative embodiments may include more, fewer, or different interactions from those illustrated in FIG. 3B, and the steps may be performed in a different order from that illustrated in FIG. 3B.

A customer associated with the customer client device 100 generates a shopping list that is provided 332 to the online system 140. The shopping list includes items to be purchased from a retailer location as part of an order that has yet to be finalized.

The online system 140 determines 334 availability of some or all of the items on the list of tracked items. The online system 140 may request availability information for some or all of the items of the list of tracked items at various retailer locations from corresponding one or more retailer computing systems 120. The one or more retailer computing systems 120 may provide updated availability information per the request. In some embodiments, the online system 140 identifies which of the tracked items are for the retailer location associated with the order, and coordinates with the retailer computing system 120 for that retailer location to obtain updated availability information for the tracked items for the retailer location.

The online system 140 retrieves 336 one or more model inputs. The model inputs include tracked items from the list of tracked items for the retailer location. The model inputs may also include shopping intent data associated with the customer (e.g., shopping cart histories, order histories corresponding to the shopping cart histories, how items were added to the shopping cart of the customer, regular purchases data associated with the customer, search histories of the customer, list of tracked items, times items have been on the list of tracked items, items for which appeasements were paid, other information relevant to determining customer buying intent for items,), item data (e.g., availability information of items on the list of tracked items at one or more retailers), customer data, order data (e.g., location of customer in retailer during an order), some other information relevant to determining whether a customer still intends to purchase an item, or some combination thereof.

The online system 140 determines 338 one or more items and their associated intent scores using an intent prediction model. The online system 140 determines the one or more items and their associated intent scores by applying the model inputs to the intent prediction model.

The online system 140 selects 340 one or more items from the one or more items output from the intent prediction model based in part on the associated intent scores. In some embodiments, the online system 140 may rank the one or more items by their associated intent scores. The online system 140 may select any of the ranked one or more items that have intent scores above a threshold intent score.

The online system 140 may provide 342 an item recommendation for each of the selected one or more items to the customer client device 100. In some embodiments, the online system 140 may generate a user interface (e.g., an ordering interface) that includes the item recommendation(s), and provide the user interface to the customer client device 100. In some embodiments, providing the item recommendation(s) also includes instructing the customer client device 100 to present the item recommendation(s) on a carousel for items for a storefront (e.g., of the retailer location) on an ordering interface of the customer client device 100. In some embodiments, providing the item recommendation(s) also includes instructing the customer client device 100 to present the item recommendation(s) in a separate section of the ordering interface than item recommendations for items that were previously purchased by the customer. A separate section may be, e.g., two different pages of the ordering interface, different carousels, etc. In some embodiments, providing the item recommendation(s) also includes instructing the customer client device 100 to present the item recommendation(s) during the checkout process (where the customer finalizes the order).

The customer client device 100 is configured to present 344 the item recommendation(s). The customer client device 100 may present the item recommendation(s) via the ordering interface. The customer client device 100 may present item recommendation(s) in accordance with instructions from the online system 140 (e.g., as part of a carousel, during the checkout process, etc.)

In some embodiments, the customer may add an item associated with one of the received item recommendation(s) to the shopping list of the order. For example, the customer may select an item recommendation that is presented via the ordering interface. The customer may use the customer client device 100 to finalize the order and provide 346 the order to the online system 140.

The online system 140 processes 348 the order, by identifying a picker associated with a picker client device 110 to shop for the order at the retailer location. The online system 140 may, e.g., identify the picker from a pool of pickers based on their locations relative to the requested source location, available cargo capacities of their vehicles, picker efficiency scores, size and number of requested items, etc. The online system 140 assigns the picker to handle the order. The online system 140 provides the assignment of the order to the picker client device 110 associated with the picker.

The picker shops for items on the shopping list of the order at the requested retailer location. The picker gathers the items, including the item on the list of tracked items, of the order from the requested retailer location, and completes the shop for the order at the retailer location. After all of the items have been collected for the order, the picker client device 110 may notify the online system 140 that all items in the order have been collected. The picker may then deliver the items to a delivery location associated with the order.

The online system 140 may update 350 the list of tracked items once the order for the item has been successfully fulfilled. For example, the online system 140 may determine that the customer ordered an item (a tracked item of the tracked items), and responsive to the order for the item being successfully fulfilled, the online system 140 may remove the item from the list of tracked items.

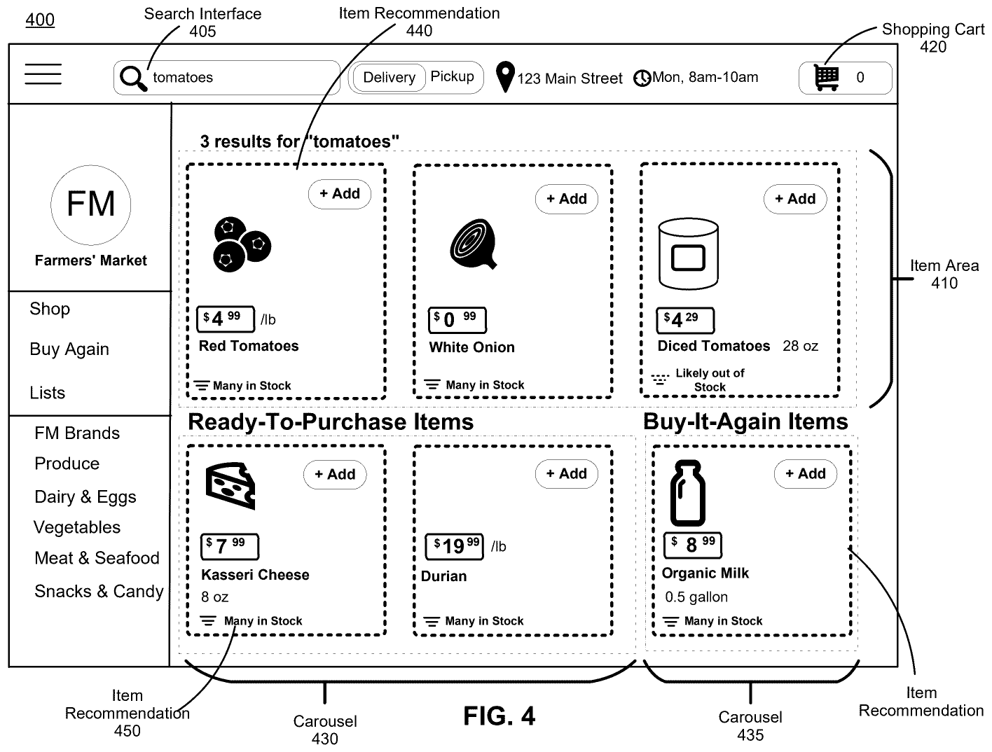

FIG. 4 illustrates an example ordering interface 400 associated with a storefront that includes a carousel 430, in accordance with some embodiments. The ordering interface 400 is an embodiment of the ordering interface described above with regard to FIGS. 1-3B. The ordering interface 400 may be presented on the customer client device 100. The ordering interface 400 is a user interface that presents food items that are available to purchase from the storefront. The storefront is a portal used by a retailer associated with the retailer computing system 120 to sell one or more items for a particular retailer location. For example, the retailer in FIG. 4 is “Farmers' Market” and the retailer location is the Farmers' Market at 123 Main Street. In the illustrated embodiment, the ordering interface 400 includes at least a search interface 405, an item area 410, a shopping cart 420, the carousel 430, and a carousel 435. In other embodiments, the ordering interface 400 includes different or additional elements. In addition, the functions may be distributed among the elements in a different manner than described.

The search interface 405 is used to search a portion of the online catalog that is specific to the retailer. In the illustrated embodiment, a customer associated with the customer client device 100 had provided a query of “tomatoes” to the customer client device via the search interface 405. The customer client device 100 provides the search query to the online system 140. The online system 140 processes the query as described above with regard to FIGS. 1-3B and provides information (e.g., item recommendations) to be presented in the item area 410 and the carousel 430.

The shopping cart 420 holds items which the customer has added to a shopping list of the order. For example, the customer may add an item associated with one of the presented item recommendations and/or item recommendations to the shopping cart 420. As items are being added to the shopping cart 420, they also are added to the shopping list for the order.

The item area 410 presents information describing various items that are for sale. In the illustrated example, the item area 410 is presenting item recommendations that correspond to the search query (“tomatoes”). For example, as shown the item area 410 presents an item recommendation 440 for “Red Tomatoes” along with several other item recommendations.

The carousel 430 presents item recommendations (e.g., an item recommendation 450 for Kasseri cheese) in accordance with instructions from the online system 140. In the illustrated example, the customer attempted to purchase the items associated with the item recommendations in one or more previous orders, but the items ended up being unavailable for some reason (e.g., was out of stock, not available in geographic location of the customer, customer could not find it, etc.). The online system 140 using the intent prediction model predicted that the customer would likely still be interested in purchasing the items and instructed the customer client device 100 to present them (e.g., via the carousel 430).

For example, the customer may want to try a recipe that uses Kasseri cheese (a specialty Greek cheese). The customer ordered the Kasseri cheese previously, but it ended up being unavailable. As described above with respect to FIGS. 1-3B, the online system 140 tracked the Kasseri cheese, determined that it was available at the retailer location that the user was generating the shopping list for, used the intent prediction model to predict that the customer would still be interested in purchasing it, and instructed the ordering interface 400 to present the corresponding item recommendation 450.

The carousel 435 presents item recommendations (e.g., an item recommendation 460 for Organic Milk) in accordance with instructions from the online system 140. The carousel presents items that the customer has regularly ordered successfully in the past. For example, the customer may order Organic Milk weekly from the Farmers' Market.

Note that items that have not been purchased before or are purchased very infrequently, are likely to be forgotten by the customer in subsequent orders and are generally not captured in a buy it again section (e.g., the carousel 435) of the ordering interface 400. For example, because the customer had not successfully had an order of Kasseri Cheese fulfilled before, it would not show up in the carousel 435 where the ordering interface 400 presents recommendations for items the customer purchases regularly. In other embodiments, where the customer infrequently orders an item (e.g., allergy medicine ordered every couple of years), even though the customer has ordered it before, it likely would not show up in the carousel 435 due to it being purchased infrequently. In contrast, an item that is infrequently purchased, and is not successfully fulfilled in a prior order, could be tracked and presented to the customer as an item recommendation in the carousel.

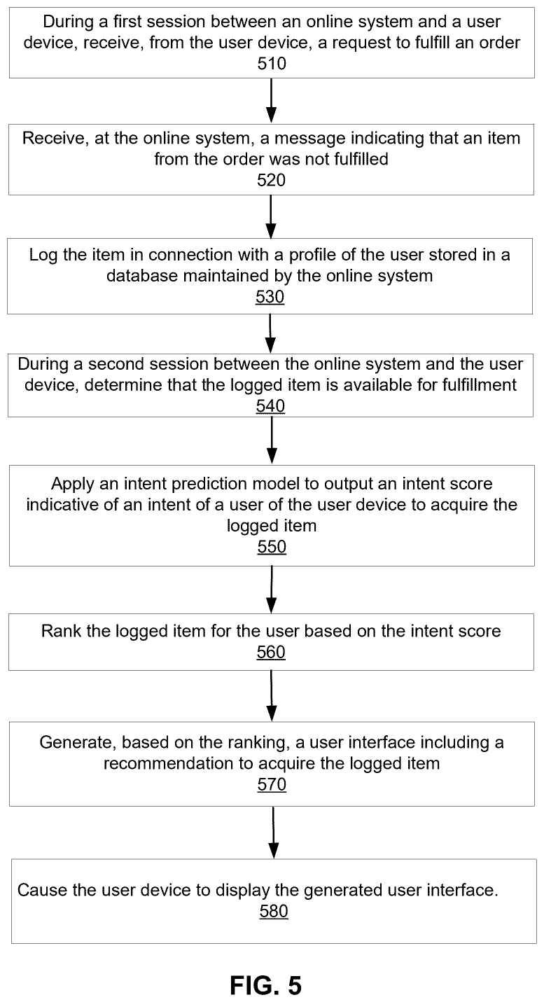

FIG. 5 is a flowchart for a method of determining item recommendations following failed attempts, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

During a first session between the online system and a user device (e.g., customer client device 100), the online system receives 510, from the user device, a request to fulfill an order. The order is a target order that includes an item.

The online system receives 520 a message indicating that the item from the order was not fulfilled. For example, during the order, the item may have been marked as likely out of stock when presented to a user of the user device and the user added the item to the order, but the item ended up being out of stock.

The online system logs 530 the item in connection with a profile of the user stored in a database maintained by the online system. The database (e.g., list of tracked items) tracks items that were part of target orders of a customer (e.g., user), but were later found to be unavailable and were not fulfilled as part of the target orders. For example, responsive to determining a mismatch between items in the order (target order) for the user and the items fulfilled order, the online system may identify that the order for the item was not fulfilled. The online system may determine whether the item is part of a list of tracked items associated with the user, and if not part of the list of tracked items, add the item to the list of tracked items (e.g., log the item in the database).

During a second session (e.g., subsequent to the first session) between the online system and the user device, the online system determines 540 that the logged item is available for fulfillment. The online system may determine whether the item is available using an availability model. In some embodiments, the online system may request availability information for the item from one or more retailer computing systems (e.g. the retailer computing system 120) associated with different retailer locations. The online system receives the updated availability information from the retailer computing systems.

The online system applies 550 an intent prediction model to output an intent score indicative of an intent of the user of the user device to acquire the logged item. In some embodiments, the online system retrieves model inputs including the item. The model inputs may also include shopping intent data associated with the customer (e.g., shopping cart histories, order histories corresponding to the shopping cart histories, how the item was added to the shopping cart of the customer in the first session, purchase history associated with the customer, search histories of the customer, list of tracked items, times items have been on the list of tracked items, items for which appeasements were paid, other information relevant to determining customer buying intent for items,), item data (e.g., availability information of items on the list of tracked items at one or more retailers), customer data, order data (e.g., location of customer in retailer during an order), some other information relevant to determining whether a customer still intends to purchase an item, or some combination thereof.

The online system ranks 560 the logged item for the user based on the intent score. The online system may select the item based on the intent score being above a threshold score (e.g., threshold confidence score).

The online system generates 570, based on the ranking, a user interface including a recommendation to acquire the logged item. The user interface may be an ordering interface.

The online system causes 580 the user device to display the generated user interface. The online system may instruct the user device to, e.g. present the item recommendation on a carousel of a storefront (e.g., of the retailer location) on the user interface, present the item recommendation in a separate section of the ordering interface than previously purchased items, present the item recommendation during the checkout process, or some combination thereof.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at an online system comprising a processor and a non-transitory computer readable medium, comprising:
during a first session between the online system and a user device, receiving, from the user device, a request to fulfill an order;
receiving, at the online system, a message indicating that an item from the order was not fulfilled;
logging the item in connection with a profile of the user stored in a database maintained by the online system;
during a second session between the online system and the user device, the second session subsequent to the first session, receiving a message indicating that the logged item is available for fulfillment;
applying an intent prediction model to output an intent score indicative of an intent of a user of the user device to acquire the logged item, wherein the intent prediction model was trained by:
accessing a set of training examples including shopping intent training data, user training data, item training data, and order training data,
applying the intent prediction model to the set of training examples to generate a training output corresponding to a predicted training set of logged items and associated training intent scores,
back-propagating one or more error terms obtained from one or more loss functions to update a set of parameters of the intent prediction model, and one or more of the error terms are based on a difference between a label applied to a test interaction of the set of training examples and the predicted training set of logged items and associated training intent scores, and
stopping the back-propagation after the one or more loss functions satisfy one or more criteria;
ranking the logged item for the user based on the intent score;
generating, based on the ranking, a user interface including a recommendation to acquire the logged item; and
causing the user device to display the generated user interface.

2. The method of claim 1, wherein receiving a message indicating that the logged item is available for fulfillment comprises:
applying an availability model to information about the logged item, the availability model outputting an indication of an availability of the logged item at one or more retailer locations.

3. The method of claim 1, wherein causing the user device to display the generated user interface comprises:
instructing the user device to present the recommendation in a separate section of user interface than item recommendations for previously purchased items.

4. The method of claim 1, wherein causing the user device to display the generated user interface comprises:
instructing the user device to present the item recommendation as part of a checkout process to complete an order associated with a shopping list.

5. The method of claim 1, wherein causing the user device to display the generated user interface comprises:
instructing the user device to present the item recommendation on a carousel for a storefront of the user interface, wherein the carousel is specific to items that were previously logged items.

6. The method of claim 1, further comprising:
during the first session,
instructing the user device to present a first item recommendation, for the item, that is marked as likely out of stock, and
receiving the order that includes the first item,
wherein applying the intent prediction model to output the intent score indicative of the intent of the user to acquire the logged item, further comprises:
applying the item and other model inputs to the intent prediction model, where the other model inputs include the order for the item when the item was marked as likely out of stock.

7. The method of claim 1, further comprising:
receiving a message indicating that the user ordered the item described by the recommendation; and
responsive to the order for the item being successfully fulfilled, removing the item from the database.

8. The method of claim 1, wherein applying the intent prediction model to output the intent score indicative of the intent of the user to acquire the logged item comprises:
applying the item and other model inputs to the intent prediction model, where the other model inputs include search histories of the user for the item.

9. The method of claim 1, wherein applying the intent prediction model to output the intent score indicative of the intent of the user to acquire the logged item comprises:
applying the item and other model inputs to the intent prediction model, where the other model inputs include item data describing whether the item was out of stock at a retailer location at a time range associated with the order, and user data including location information of the user within the retailer location during the time range.

10. The method of claim 1, further comprising:
logging additional training examples using item recommendations derived from the intent prediction model and purchases by the user of items associated with those recommendations; and
retraining the intent prediction model based in part on the additional training examples.

11. A non-transitory computer-readable storage medium comprising stored instructions, the instructions when executed by a processor of an online system, cause the online system to perform steps comprising:
during a first session between the online system and a user device, receiving, from the user device, a request to fulfill an order;
receiving, at the online system, a message indicating that an item from the order was not fulfilled;
logging the item in connection with a profile of the user stored in a database maintained by the online system;
during a second session between the online system and the user device, the second session subsequent to the first session, receiving a message indicating that the logged item is available for fulfillment;
applying an intent prediction model to output an intent score indicative of an intent of a user of the user device to acquire the logged item, wherein the intent prediction model was trained by:
accessing a set of training examples including shopping intent training data, user training data, item training data, and order training data,
applying the intent prediction model to the set of training examples to generate a training output corresponding to a predicted training set of logged items and associated training intent scores,
back-propagating one or more error terms obtained from one or more loss functions to update a set of parameters of the intent prediction model, and one or more of the error terms are based on a difference between a label applied to a test interaction of the set of training examples and the predicted training set of logged items and associated training intent scores, and
stopping the back-propagation after the one or more loss functions satisfy one or more criteria;
ranking the logged item for the user based on the intent score;
generating, based on the ranking, a user interface including a recommendation to acquire the logged item; and
causing the user device to display the generated user interface.

12. The non-transitory computer-readable storage medium of claim 11, wherein receiving a message indicating that the logged item is available for fulfillment comprises:
applying an availability model to information about the logged item, the availability model outputting an indication of an availability of the logged item at one or more retailer locations.

13. The non-transitory computer-readable storage medium of claim 11, wherein causing the user device to display the generated user interface comprises:
instructing the user device to present the recommendation in a separate section of user interface than item recommendations for previously purchased items.

14. The non-transitory computer-readable storage medium of claim 11, wherein causing the user device to display the generated user interface comprises:
instructing the user device to present the item recommendation as part of a checkout process to complete an order associated with a shopping list.

15. The non-transitory computer-readable storage medium of claim 11, wherein causing the user device to display the generated user interface comprises:
instructing the user device to present the item recommendation on a carousel for a storefront of the user interface, wherein the carousel is specific to items that were previously logged items.

16. The non-transitory computer-readable storage medium of claim 11, further comprising stored instructions that when executed cause the online system to perform steps comprising:
during the first session,
instructing the user device to present a first item recommendation, for the item, that is marked as likely out of stock, and
receiving the order that includes the first item,
wherein where the stored instructions to apply the intent prediction model to output the intent score indicative of the intent of the user to acquire the logged item,, further comprises stored instruction that when executed cause the online system to:
apply the item and other model inputs to the intent prediction model, where the other model inputs include the order for the item when the item was marked as likely out of stock.

17. The non-transitory computer-readable storage medium of claim 11, further comprising stored instructions that when executed cause the online system to perform steps comprising:
receiving a message indicating that the user ordered the item described by the recommendation; and
responsive to the order for the item being successfully fulfilled, removing the item from the database.

18. The non-transitory computer-readable storage medium of claim 11, wherein applying the intent prediction model to output the intent score indicative of the intent of the user to acquire the logged item comprises:
applying the item and other model inputs to the intent prediction model, where the other model inputs include search histories of the user for the item.

19. The non-transitory computer-readable storage medium of claim 14, further comprising stored instruction that when executed cause the online system to perform steps comprising:
logging additional training examples using item recommendations derived from the intent prediction model and purchases by the user of items associated with those recommendations; and
retraining the intent prediction model based in part on the additional training examples.

20. An online system comprising:
a processor; and
a non-transitory computer readable storage medium having instructions encoded thereon that, when executed by the processor, cause the online system to perform steps comprising:
during a first session between the online system and a user device, receiving, from the user device, a request to fulfill an order;
receiving, at the online system, a message indicating that an item from the order was not fulfilled;
logging the item in connection with a profile of the user stored in a database maintained by the online system;
during a second session between the online system and the user device, the second session subsequent to the first session, receiving a message indicating that the logged item is available for fulfillment;
applying an intent prediction model to output an intent score indicative of an intent of a user of the user device to acquire the logged item, wherein the intent prediction model was trained by:
accessing a set of training examples including shopping intent training data, user training data, item training data, and order training data,
applying the intent prediction model to the set of training examples to generate a training output corresponding to a predicted training set of logged items and associated training intent scores,
back-propagating one or more error terms obtained from one or more loss functions to update a set of parameters of the intent prediction model, and one or more of the error terms are based on a difference between a label applied to a test interaction of the set of training examples and the predicted training set of logged items and associated training intent scores, and
stopping the back-propagation after the one or more loss functions satisfy one or more criteria;
ranking the logged item for the user based on the intent score;
generating, based on the ranking, a user interface including a recommendation to acquire the logged item; and
causing the user device to display the generated user interface.
